(19) United States
(12) Patent Application Publication
(10) Pub. No.: US 2014/0324495 A1
(43) Pub. Date: Oct. 30, 2014

(54) WIND TURBINE MAINTENANCE OPTIMIZER

(71) Applicant: VESTAS WIND SYSTEMS A/S, Aarhus N (DK)

(72) Inventors: Yu ZHOU, Singapore (SG); Mohamed Faisal Bin MOHAMED SALLEH, Singapore (SG); Sridhar SAHUKARI, Houston, TX (US); Pey Yen SIEW, Singapore (SG); Sunita SINGH, Sugar Land, TX (US); Wanying CHEN, Singapore (SG); Scott MUTCHLER, Eirie, CO (US)

(73) Assignee: VESTAS WIND SYSTEMS A/S, Aarhus N (DK)

(21) Appl. No.: 14/186,816

(22) Filed: Feb. 21, 2014

Related U.S. Application Data
(60) Provisional application No. 61/768,352, filed on Feb. 22, 2013.

(51) Int. Cl. G06Q 10/06; G06Q 40/00; G06Q 50/06

(52) U.S. Cl. CPC G06Q 10/06311; G06Q 50/06; G06Q 40/125
USPC 705/7.13

(57) ABSTRACT

Determining when to perform preventative maintenance is an important consideration for maximizing the revenue of a wind turbine. For example, performing preventative maintenance may be cheaper than replacing turbine components when they fail. When determining to perform preventative maintenance, a maintenance scheduler may consider multiple factors. These factors may include the probability of failure, the predicted price of energy, predicted wind power production, resource constraints, and the like. Specifically, the maintenance scheduler may predict the future values of these factors which are then integrated into a net present value (NPV) for each of the components. Based on the respective NPVs, the maintenance scheduler may determine which maintenance actions to perform and in what order.

### CROSS-REFERENCE TO RELATED APPLICATIONS

This application is a non-provisional of provisional application 61/768,352, filed Feb. 22, 2013. The aforementioned related patent application is herein incorporated by reference in its entirety.

### BACKGROUND

1. Of the Invention

Embodiments of the invention generally relate to performing maintenance on wind turbines and, more particularly, to considering revenue when scheduling preventative maintenance tasks.

2. Description of the Related Art

Wind turbines are often situated in remote areas to take advantage of prevalent weather patterns in the area. In these remote areas, the wind turbines are often exposed to extreme environmental conditions. These extreme environmental conditions include, but are not limited to, extreme temperatures, rain, snow, ice, blowing debris, and rough seas. These harsh conditions may cause premature failure of components in a turbine. In addition, inspection and maintenance of the wind turbines is much more difficult and often more expensive to complete. Accordingly, performing preventive maintenance to avoid component failure may be a cost-effective technique for maximizing the revenue produced by a wind turbine by preventing or minimizing power disruption associated with the component failure.

### SUMMARY

Embodiments of the present disclosure are a method, system, and computer program product for scheduling maintenance tasks in a power plant. The method, system, and computer program product include generating, based on a plurality of inputs, respective net present values associated with performing maintenance on two components in the power plant, wherein at least one of the plurality of inputs is a value that predicts at least one of: a future performance of the two components and a future price of electrical power. The method, system, and computer program product include determining a priority between the two components based on at least in part the respective net present values. The method, system, and computer program product also include generating, based on the determined priority, a maintenance schedule for performing a preventative maintenance task on at least one of the two components

An embodiment of the present disclosure is a method of scheduling maintenance tasks in a wind power plant. The method includes receiving a probability of failure associated with a component in a wind turbine in the wind power plant. The method includes receiving a predicted energy price representing an expected price of electrical power on a utility grid coupled to the wind power plant. The method includes receiving a predicted wind power production of the wind turbine representing an expected amount of power that will be produced by the wind turbine. The method includes generating, based on the probability of failure, predicted energy price and predicted wind power production, a revenue indicator associated with performing maintenance on the component. The method includes generating, based on the revenue indicator, a maintenance schedule for performing a preventative maintenance task on the component.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates a diagrammatic view of a wind turbine generator, according to one embodiment described herein.

FIG. 2 illustrates a maintenance scheduler, according to one embodiment described herein.

FIG. 3 illustrates a flow chart for calculating a probability of component failures, according to one embodiment described herein.

FIGS. 4A-4B illustrate risk curves associated with calculating a probability of failures, according to embodiments described herein.

FIG. 5 illustrates an energy price forecasting technique, according to one embodiment described herein.

FIG. 6 illustrates a wind power forecasting technique, according to one embodiment described herein.

FIG. 7 illustrates a technique for calculating the net present value of performing a maintenance action, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Determining when to perform preventative maintenance is an important consideration for maximizing the revenue of a wind turbine. For example, performing preventative maintenance may be cheaper than replacing turbine components when they fail. When determining to perform preventative maintenance, a maintenance scheduler may consider multiple factors. These factors may include the probability of failure, the predicted price of energy, predicted wind power production, resource constraints, and the like. Specifically, the maintenance scheduler may predict the future values of these factors which are then integrated into a net present value (NPV) for each of the components. Based on the respective NPVs, the maintenance scheduler may determine which maintenance actions to perform and in what order.

Embodiments of the present invention will now be explained in further details. While the invention is susceptible to various modifications and alternative forms, specific embodiments have been disclosed by way of examples. It should be understood, however, that the invention is not intended to be limited to the particular forms disclosed. Rather, the invention is to cover all modifications, equivalents, and alternatives falling within the spirit and scope of the invention as defined by the appended claims.

### An Example Wind Turbine Generator

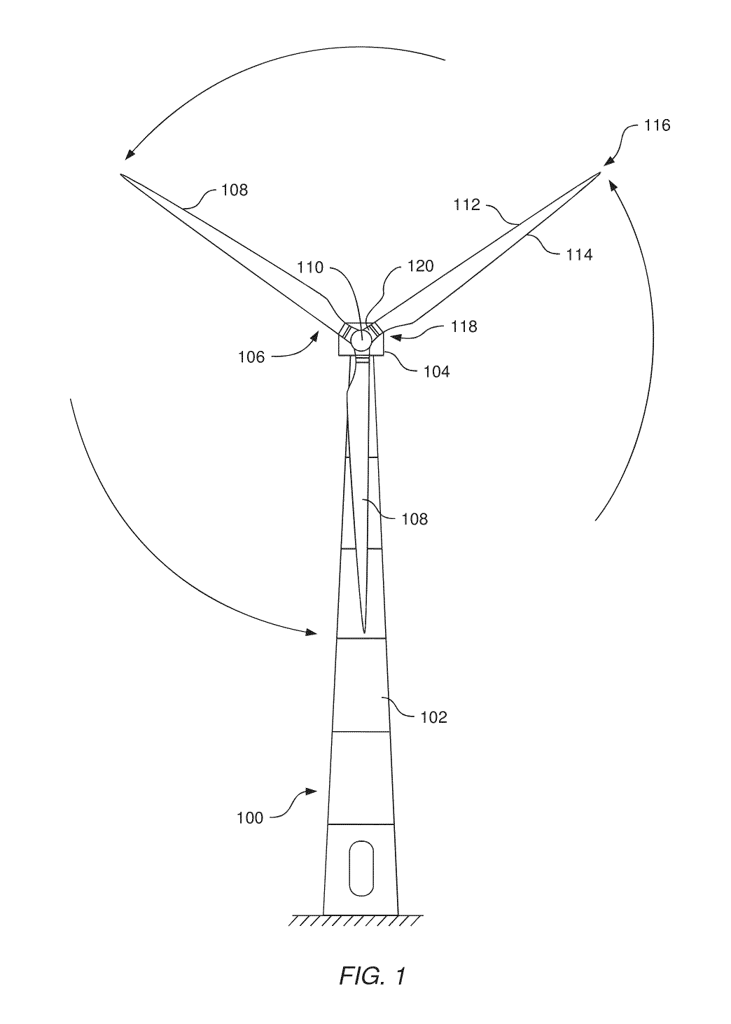

FIG. 1 illustrates a diagrammatic view of a horizontal-axis wind turbine generator 100. The wind turbine generator 100 typically includes a tower 102 and a wind turbine nacelle 104 located at the top of the tower 102. A wind turbine rotor 106 may be connected with the nacelle 104 through a low speed shaft extending out of the nacelle 104. The wind turbine rotor 106 includes three rotor blades 108 mounted on a common hub 110, but may include any suitable number of blades, such as one, two, four, five, or more blades. The blade 108 (or airfoil) typically has an aerodynamic shape with a leading edge 112 for facing into the wind, a trailing edge 114 at the opposite end of a chord for the blade 108, a tip 116, and a root 118 for attaching to the hub 110 in any suitable manner.

For some embodiments, the blades 108 may be connected to the hub 110 using pitch bearings 120 such that each blade 108 may be rotated around its longitudinal axis to adjust the blade's pitch. The pitch angle of a blade 108 may be controlled by linear actuators or stepper motors, for example, connected between the hub 110 and the blade 108.

### Scheduling Maintenance Tasks

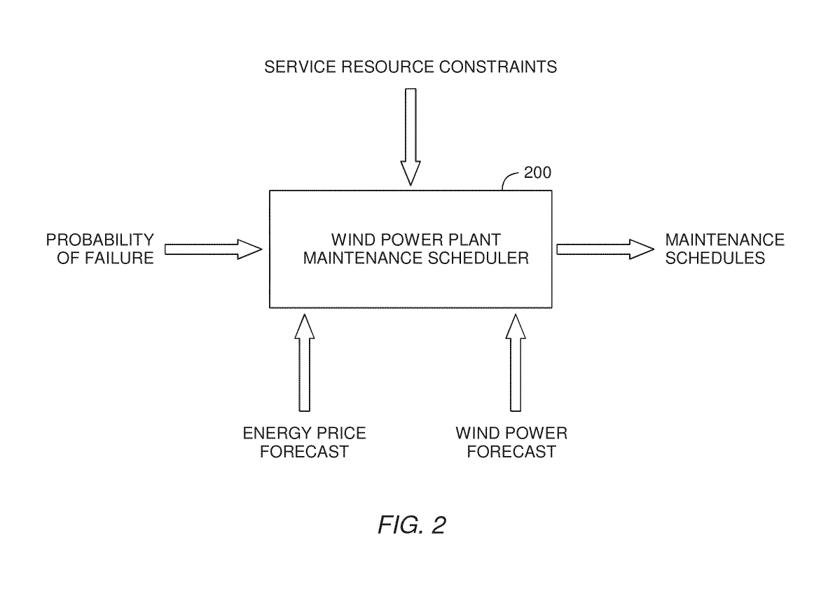

FIG. 2 illustrates a maintenance scheduler, according to one embodiment described herein. The maintenance scheduler 200 may receive input from a plurality of different models or modules that influence when to perform preventative maintenance. In one embodiment, the scheduler 200 integrates the variety of inputs (or maintenance factors) into a net present value associated with a particular component in a wind turbine. The NPV is then used to determine what maintenance actions to perform. As shown, the maintenance scheduler 200 receives a probability of failure, an energy price forecast, a wind power forecast, and service resources constraints. Each of these maintenance factors may be calculated by the maintenance scheduler 200 or transmitted to the scheduler 200 from a separate module or model. Moreover, although four inputs are shown, the scheduler 200 may generate a maintenance schedule using less than these inputs or more than these inputs as desired. That is, the embodiments described below may be modified to include any number of maintenance factors when generating a maintenance schedule.

The maintenance scheduler 200 may be responsible for scheduling maintenance for the various components in a wind turbine (e.g., a generator bearing, planetary gear, generator windings, blades, electrical systems, etc.). Each component may be associated with a different probability of failure that may be based on the current wind conditions, vibrations in the component, age of the component, and the like. In addition, the future or predicted price of energy (e.g., price per megawatt) may be provided to the scheduler 200. The energy price may be based on historical data such consumer demand, temperature (or seasons), or utility grid load as well as other factors such as the power capacity of other electrical generation systems (e.g., coal plants, gas, hydroelectric, and the like). If, for example, the goal is to maximize revenue, the preventative maintenance (which may cause the turbine to be offline) may be performed when energy prices are predicted to be low.

As shown, the maintenance scheduler 200 may also receive a wind power forecast that predicts the amount of wind power available based on current and future weather forecasts. The scheduler 200 may determine to schedule the maintenance when wind power generation is low to maximize the amount of electricity the turbine generates, and thus, the revenue the turbine produces. Further still, the net present value calculation may also be influenced by the service resources such as availability of technicians, cost of labor, availability of spare parts and the like.

In one embodiment, after receiving the maintenance factors, the maintenance scheduler 200 uses an algorithm to generate a plurality of net present values for a particular component that each correspond to a future date. These values may then be compared to other net present values associated with other components in the wind turbine or components located in different turbines within the wind farm. Generating net present values for each of the components enable the scheduler 200 to compare the maintenance needs of each component, even if the components are different (e.g., a generator versus a turbine blade). Moreover, the scheduler 200 may include an optimizer for scheduling maintenance tasks to satisfy a particular goal, such as maximizing the revenue of the wind turbine, minimize the risk of failure of critical components, maximize the utilization of value chain, and the like.

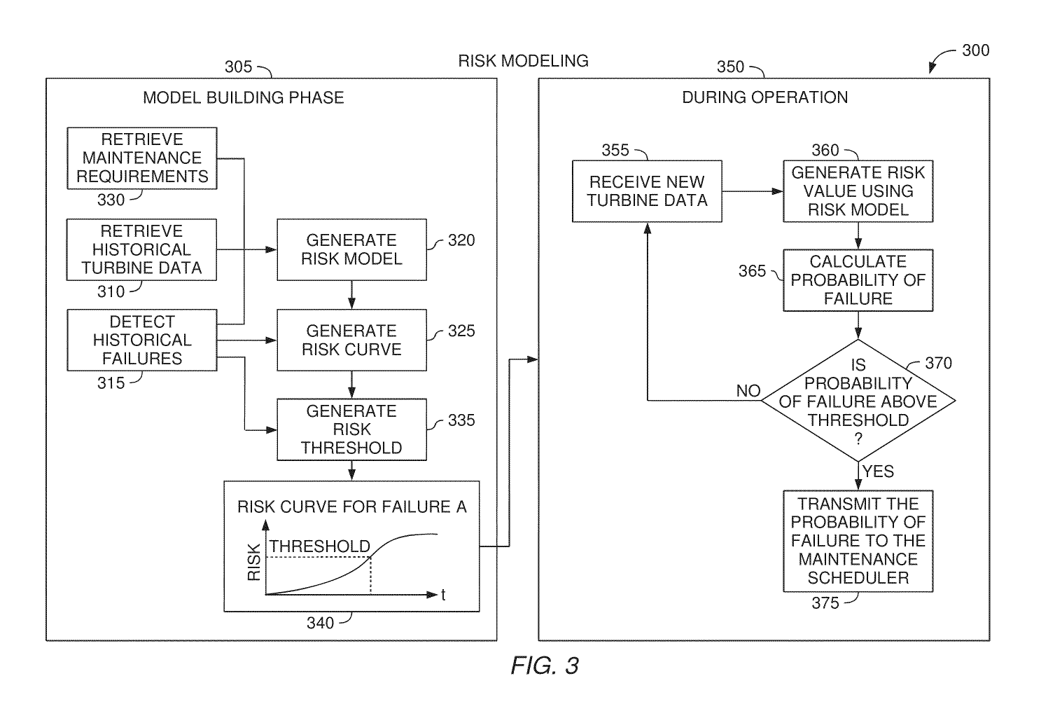

FIG. 3 illustrates a flow chart for calculating a probability of component failures, according to one embodiment described herein. Specifically, the method 300 may be used to generate the probability of failure used as in input to the maintenance scheduler 200 shown in FIG. 2. In one embodiment, the method 300 may be divided into two stages: the development process 305 and the execution process 350. The development process 305 begins at blocks 310 and 315 where a risk modeling module (a software application) may retrieve historical data for an identified group of wind turbines. In one embodiment, the risk modeling module may retrieve data from sensors in the wind turbines in the wind farm. The sensors may measure the power output of a particular component, the vibrations in (or proximate to) a component, temperature of a component, environmental conditions (e.g., wind speed, icing, temperature), and the like. Also, the risk modeling module may retrieve error log data and event log data such as when a component transmits an error signal or indicates there is a maintenance issue (e.g., low oil pressure). In addition to retrieving the historical data, the risk modeling module may monitor the different components to determine when the components fail. For example, the risk modeling module may monitor the generator bearings in each turbine in the wind farm for a year to determine how many fail during that span. Thus, the historical failure data retrieved in block 315 may be used to correlate historical turbine data (e.g., sensor data, error log data, and event log data) to the age of the component when it failed.

In block 320, the risk modeling module generates a risk model based on the historical turbine data mined at block 310 and the historical failure information mined at block 315. In one embodiment, the risk modeling module may compare the sensor data, error log data, event log data associated with components that failed to the same data associated with components that did not fail during the monitored time period. Stated differently, the sensor data from block 310 is correlated with the date that a component failed (or did not fail) from block 315. The data sources that generate different data for components that fail versus components that do not fail may be indicative of a component's failure. Accordingly, these data sources may be characterized as relevant and be used as inputs to generate the risk model. For example, if a particular vibration signal reported 20% more vibration associated with components that failed versus components that did not, the vibration signal may be used when defining the risk model. In one embodiment, the different data sources may also be correlated to each other (i.e., how one data source may affect another data source) to see if there is a difference between correlations where the components failed and where the components did not. For example, the temperature of a component may vary with wind speed in components that fail but not in components that do not fail. Thus, this correlation may be deemed relevant and used as input when generating the risk model. The data sources or the correlation of data sources that are not relevant may be ignored.

Once the risk model inputs are identified, the different data sources may be weighted to yield a risk model (Z):

Z=α+β×Input1+γ×Input2+ . . . +δ×InputN (1)

The weighting values (α, β, γ, and δ) may be any numerical value and Input1−InputN may be the relevant data sources. These data sources may also be selected by evaluating histograms and correlation for the data over various time periods—7, 90, 365 days—before a component's failure. After determining the relevant inputs for the risk model, the different inputs may then be weighted using the values α, β, γ, and δ. That is, some of the relevant inputs may have a greater affect on the probability of failure than other inputs. In this manner, the risk model module may generate the risk model based on data mined from a plurality of wind turbines (or components) in a wind farm.

In one embodiment, the development process 305 of the method 300 may occur during a configuration stage of starting a new wind farm to generate a new risk model. Alternatively, the risk model module may use a predefined risk model to schedule maintenance tasks that is based on data mined from other similar wind farms when the new wind farm is first brought online. The predefined risk model may be refined or substituted by a new risk model after mining data from the new wind farm as shown in blocks 310, 315, and 320.

The probability of failure (pf) may be expressed by:

pf=1/(1−e^{z}) (2)

where Z is the risk model shown in Equation 1. At block 325, the probability of failure (which is based on the risk model) and the historical failure may be combined to generate a risk curve. The probability of failure provides a risk of a particular component failing based on certain input values. This risk can also be correlated to the age of the component to yield a risk curve. To do so, the historical failure, which identifies an age at which components in the wind farm have failed previously, is used to correlate the probability of failure with the age of the component. Accordingly, the risk curve illustrates the probability of failure based on both the relevant inputs found from data mining as well as the age of the component.

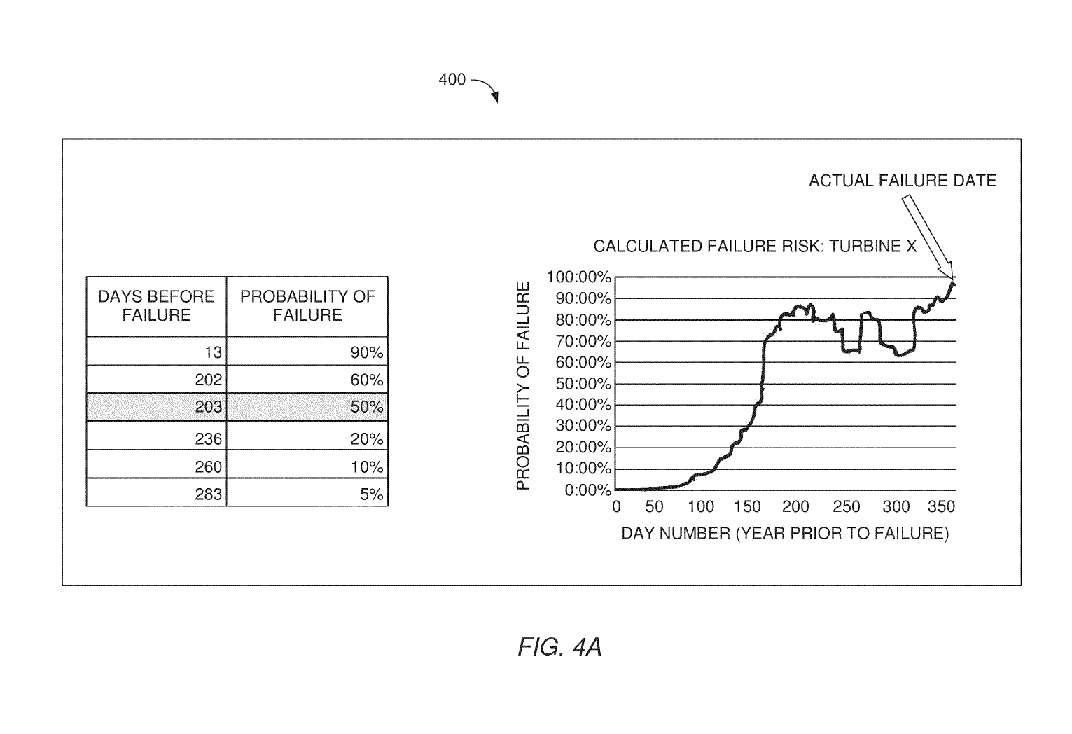

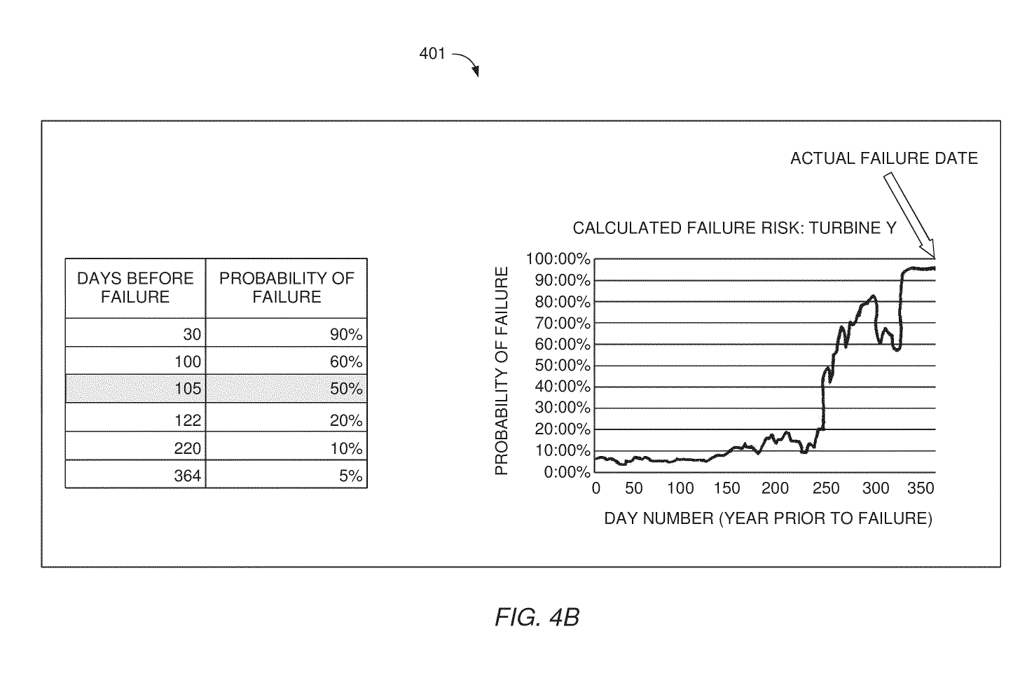

FIGS. 4A-4B illustrate risk curves associated with calculating a probability of failures, according to embodiments described herein. Chart 400 illustrate the combination of the historical failure data and the risk model to generate a risk curve. As shown, the risk curve may not maintain a positive slope. That is, the risk curve shown in FIG. 4A illustrates that the probability of failure may be actual decrease as the component in Turbine X ages. Because the probability of failure is affected by such factors as environmental conditions, during days 150-240 the turbine may experience high wind conditions that increase the likelihood the component will fail. However, as the wind abates, the probability of failure may decrease. Stated differently, during the spike in the probability of failure, the risk model (which is based on the sensor data, error logs, or event logs) may dominate the probability of failure while the age of the component is less of a factor. Thus, the risk curve illustrates the effect of both the age of the component and the current status of the sensor signals, error logs, and event logs on the probability of failure.

FIG. 4B illustrates another risk curve in chart 401. Here, the risk curve for the component on Turbine Y also may increase or decrease. The combination of aging and weather conditions eventually lead to the component's failure. For example, the sudden spike right before the component fails may be a sudden increase in the wind speeds. Assume that the same sudden increase occurred during day 250, but because the component was younger, it was able to withstand this increase without failing. However, the same increase in wind speed at day 350 in combination with the increased age of the component causes the component to fail.

Returning to FIG. 3, at block 330 the risk model module retrieves maintenance requirements associated with the components in the monitored turbines. The maintenance requirements may be based on a contract signed between a company that performs the maintenance and the owners of the wind farm. The contract may stipulate how often scheduled maintenance may occur and how much each maintenance task costs. As a component in the turbine is scheduled according to the maintenance schedule outlined in the service contract, the risk curve could change because the scheduled maintenance changes the probability of failure. In this manner, the maintenance requirements may be used as an input for generating the risk model at block 320.

At block 335, one or more risk thresholds may be added to a risk curve based on historical failures. The one or more thresholds are added to the risk curves where each threshold may correspond to a different action or characterize the component in a different manner. For example, if the probability of failure exceeds a first threshold, the component may be assigned a yellow warning, but if the probability of failure exceeds a second threshold, the component is assigned a red warning.

The maintenance scheduler may use the yellow warning to schedule maintenance on the component only if the maintenance is convenient and will not substantially hinder the revenue of the turbine—e.g., the turbine is not generating much power. A red warning, in contrast, may indicate to the maintenance scheduler to perform maintenance soon since the failure of the component may cause a greater loss of revenue than if the turbine was taken offline temporarily for preventative maintenance. For example, the turbine may be part of an offshore wind farm. If the maintenance is not performed during a routine maintenance trip to the farm and the component fails, replacing the component may require a special maintenance trip that may be expensive or the turbine may remain offline until another scheduled maintenance trip which increases the amount of time the turbine is not generating power. Thus, a component with a red warning may be given higher priority than a component with a yellow warning.

Block 340 illustrates an example risk curve with a single threshold added to the curve. In other embodiments, additional threshold may be added to the risk curve as discussed above. Once the risk curve and any desired thresholds are generated, the method 300 may switch from the development process 305 to the execution process 350.

At block 355, the risk model module may receive updated data from the different data sources associated with a wind turbine. At block 360, the received data is used to identify a risk value using the risk model shown in Equation 1. At block 365, the risk value may then be used to calculate the probability of failure using Equation 2.

At block 370, the risk model module determines whether the probability of failure is above one or more of the risk thresholds that were identified at block 340. If not, the method 300 returns to block 355 to wait for new data from the data sources. If, however, the probability of failure exceeds one of the risk thresholds, at block 375, the module transmits a message containing the probability of failure to the maintenance scheduler. In one embodiment, instead of transmitting the probability of failure (e.g., a percentage), the module may transmit the status or characterization of the component (e.g., green, yellow, or red).

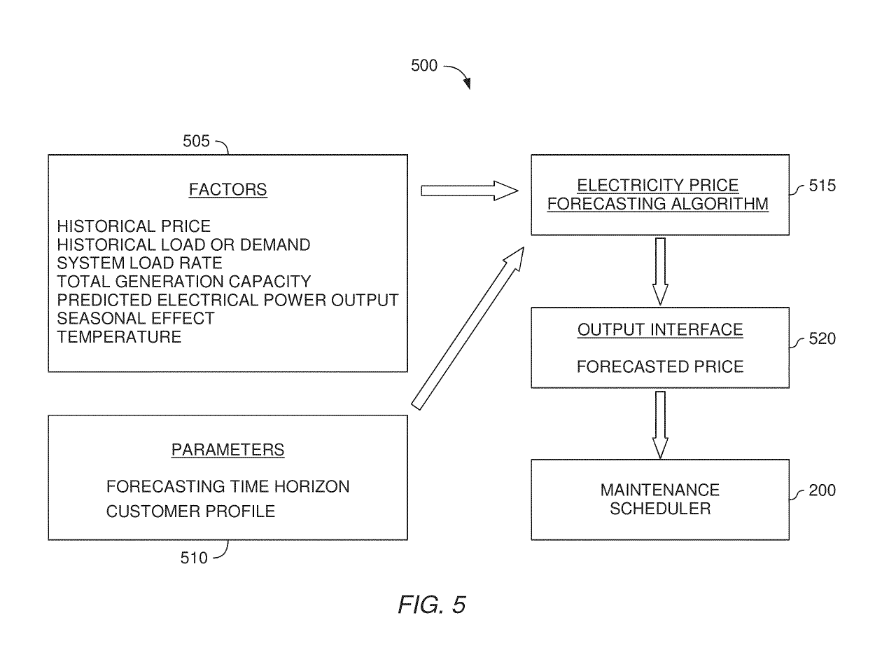

FIG. 5 illustrates an energy price forecasting technique, according to one embodiment described herein. The system 500 considers one or more pricing factors 505 and parameters 510 for predicting the price of energy (e.g., price per megawatt) at a future date. Example factors 505 include the historical price of energy, historical load or demand, system load rate, the total possible generation capacity of all the different energy power plants attached to the grid, predicted electrical generation of the different energy power plants attached to the grid, seasonal effects of weather, and temperature (current or predicted). Energy price may be predicted based on supply and demand models. Some of the factors 505 may be used to calculate the supply while others are used to calculate the demand. To estimate the total supply, an energy price module (a software application) may consider the predicted electrical generation of the different power plants or the total generation capacity of the power plants coupled to the utility grid. For some power plants, e.g., coal or nuclear power, the electrical generation may be relatively stable while other power plants, e.g., hydroelectricity, may vary based on environmental conditions. That is, a dam may produce less electricity during a drought when water levels are low. Moreover, the total generation capacity may change as new power plants are connected to the same grid as the wind farm.

Other factors 505, such as historical demand or loading, system load rate, and the weather, may be used to predict demand. For example, the extreme temperatures in summer and winter may cause demand to increase relative to the milder temperatures in spring and fall. Furthermore, the rate at which new loads (e.g., new residential neighborhoods) are being added to the utility grid may also indicate how demand may change in the future. Moreover, the historical price may also be used to further refine the predicted supply or demand. Of course, the energy price module may consider more or less than these factors when predicting a future price of energy.

The energy price module may also receive as an input the parameters 510 which include a forecasting time horizon and a customer profile. The time horizon may provide the energy price module with a time frame to predict the future energy price—e.g., calculate the future price for the next sixty days. The customer profile may customize the energy price to correspond to the needs of the customer (i.e., the wind farm owner).

The factors 505 and parameters 510 may be inputs into an electricity price forecasting algorithm 515 of the energy price module. In one embodiment, the algorithm 515 uses a fuzzy neural network method to predict the future price of energy based on the factors 505 and the parameters 510. In other embodiments, the algorithm 515 may generate supply and demand curves based on the factors and estimate the cost of energy based on those curves. However, the energy price algorithm 515 is not limited to any particular type of forecasting model or technique. Regardless of the technique used, the system 500 may transmit these prices to the output interface 520. The interface 520 may display the forecasted prices or transmit the prices directly to the maintenance scheduler 200 for further processing.

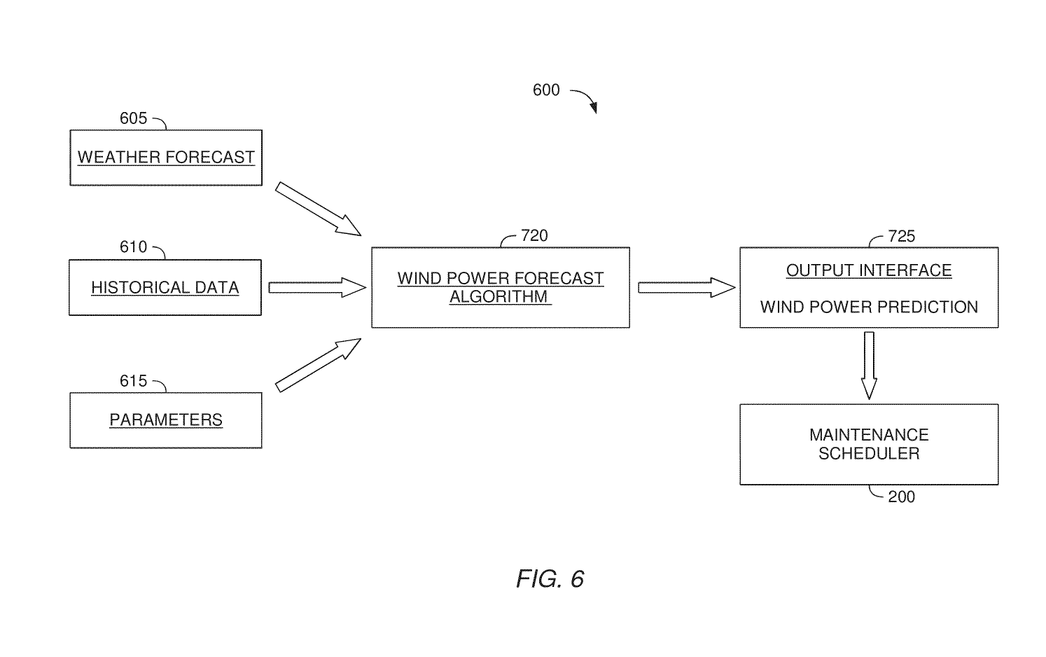

FIG. 6 illustrates a wind power forecasting technique, according to one embodiment described herein. The system 600 includes a wind power forecast algorithm 620 in a wind power module (a software application) that receives as inputs a weather forecast 605, historical data 610, and parameters 615. The weather forecast 605 may include temperature, barometric pressure, pressure systems, movement of the jet stream, and any other atmospheric condition that may affect the amount of power the turbines can generate. The weather forecast data 605 may come from a public data source (e.g., a government service) or from measuring different weather sensors associated with the wind farm whose values are then used to generate the forecast. The historical data 610 may include the previously measured weather conditions as well as previous wind power outputs of the wind farm. In one example, historical data 610 may include an average wind speed for a particular calendar day. Moreover, the historical data 610 may be used to interpret the weather forecast data 605. For example, the historical data 610 may indicate that when a low pressure front moves through, the wind speed averages 8 meters/second. Thus, if the weather forecast data 605 indicates a low pressure front will pass over the wind farm, the expected wind speed will be around 8 m/s.

The parameters 615 may include the same parameters as the parameters 510 shown in FIG. 5. That is, the wind power module may predict the wind power for a given time frame and based on a specific customer profile. In addition to those parameters, parameters 615 may include the type of turbine in the wind farm. For the same wind speed, different turbines generate different amounts of power. This information may be transmitted to the wind power module so the module can accurately predict the wind farm's output power based on a received wind speed. The parameters 615 may also define a wake effect where downstream turbines generate a reduced amount of power because of the wake generated by upstream turbines. In one embodiment, the wake effect is dependent upon the direction of wind entering the wind farm which can be another input into the wind power module.

The wind power forecast algorithm 620 uses the inputs discussed above to predict a future wind speed and the wind power output of the wind farm for the time period stipulated in the parameters 615. In one embodiment, the algorithm 620 uses an artificial neural network based on a forecasting model to predict the future wind power. However, the wind power forecast algorithm 620 is not limited to any particular type of forecasting model or technique. An output interface 625 may display the predicted wind power prediction or predictions. Alternatively, the output interface 625 may transmits the predictions directly to the maintenance scheduler 200.

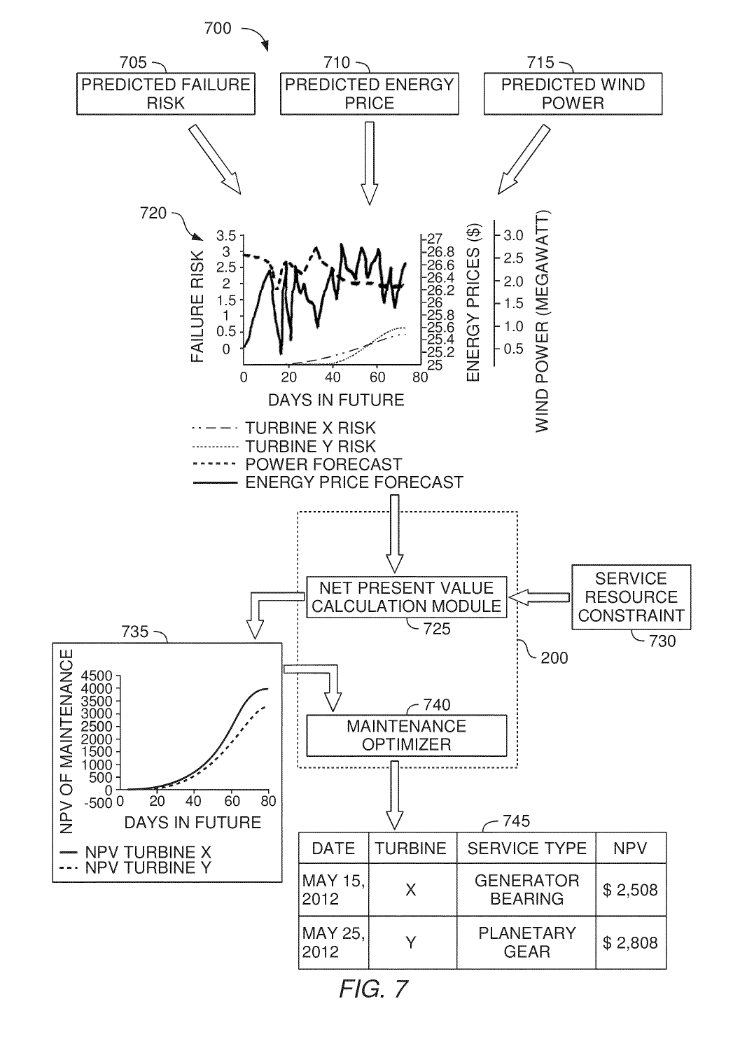

FIG. 7 illustrates a technique for calculating the net present value of performing a maintenance action, according to one embodiment described herein. Specifically, the system 700 illustrates using the predicted failure risk (or probability of failure) 705, predicted energy price 710, and predicted wind power 715 calculated in FIGS. 4, 6, and 7, respectively, to calculate a net present value curve for performing maintenance on a component in a wind turbine. The three inputs 705, 710, and 715 are shown in chart 720. For a specified time period (e.g., 70 days in the future), the chart 720 illustrates the predicted wind power, the predicted energy price, and the risks of failure for a component in Turbine X and a component in Turbine Y. The components may either be the same type of component (e.g., both generator bearings) or different components (e.g., a generator bearing in Turbine X and a planetary gear in Turbine Y). The leftmost Y axis illustrates the failure risk while the two rightmost Y axes correspond to energy price and wind power, respectively.

The NPV calculation module 725 uses these inputs to calculate the net present value for each component—e.g., the NPV for the component in Turbine X and the NPV for the component in Turbine Y. Also, the NPV module 725 may consider service resource constraints 730. Service resource constraints 730 include labor concerns—e.g., cost of labor, availability of labor, overtime costs, specialties of the technicians, and the like—and inventory limitations—e.g., availability of replacement parts, cost of parts, current inventory, transit time for shipping replacements, and the like. For example, if performing maintenance on a component would require paying a technician overtime or paying extra for rush delivery of a part, these costs may be considered by the NPV calculation module 725. In one embodiment, the NPV calculation module 725 uses the predicted failure risk 705, predicted energy price 710, predicted wind power 715, and the service resource constraints 730 when calculated a NPV for each component. For a particular turbine component, because the failure probability risk model is developed based on all the possible failure modes, the NPV is found by summing across all the modes:

NPV=Σ_{for all modes}pf×Δc (3)

where pf is the probability of failure (i.e., predicted failure risk 705), which varies depending on the age of the turbine, and Δc is the cost difference between the cost of preventative maintenance and the cost of fixing the component if it fails (i.e., allowing the turbine to “run to failure”). The cost of preventive maintenance is the cost of lost production revenue plus the cost of parts and labor. In turn, the cost of lost production revenue is defined by:

c_{lost revenue}=Σ_{maintenance days}energy price×wind power (4)

Thus, the predicted energy price 710 and predicted wind power 715 are used to find the cost of lost revenue. The cost of lost revenue and the costs associated with the service resource constraints 730 (parts and labor) are then used to determine the cost of preventive maintenance. The cost of fixing the component when it fails may be found in a look-up table. The cost difference between the cost of fixing the component when it fails and the cost of preventive maintenance is then multiplied with the probability of failure to yield the NPV.

Generally, preventative maintenance has lower fixed costs (due to less direct and collateral damage occurring when a component breaks or fails) and lower variable costs due to reduced labor cost and lost energy production since turbines are typically offline for shorter amounts of time during preventative maintenance compared to fixing or replacing components that have failed.

Chart 735 illustrates the two NPV curves calculated for the components in Turbine X and Y, respectively. As expressed in Equations 3 and 4, the NPV curves change according to the fluctuating values for the failure risk, energy price, and wind power shown in chart 720 in addition to the service resource constraints. Generally, the NPVs represent the benefit of performing preventative maintenance versus waiting until a component fails. However, the NPVs also consider the likelihood of the failure happening—i.e., the probability of failure. That is, the benefit of performing the preventative maintenance is more likely to be realized if the failure is more likely to occur. Thus, the NPV increases as the probability of failure increase but decreases as the probability of failure decreases. The NPV curves of chart 735 illustrate the predicted NPVs of performing the maintenance up to 70 days in the future. The NPV for the first days (e.g., days 1-20) is very low because the probability of failure as shown in chart 720 is very low. However, as the failure probability increases, the NPV also increases. Although chart 735 illustrates two NPV curves where the slope constantly increases, this might not always be the case. For other turbine components, the NPV curve may have portions that are flat or the slope may decrease. Generally, the turbine with the higher NPV for a selected date if chosen to for the maintenance task. As shown in chart 735, because Turbine X has a higher NPV value for all the days in the future, it is chosen for preventative maintenance before Turbine Y. In one embodiment, the system 700 may consider the probability of failure. For example, if the NPV values for two turbines are approximately the same for a given date, the system 700 may choose the turbine with the highest predicted probability of failure for that date.

The system 700 may include a maintenance optimizer 740 that evaluates one or more NPV curves and determines an optimized schedule for performing maintenance. The optimizer 740 may use any optimizing algorithms compatible with the embodiment described herein. Moreover, the maintenance optimizer 740 may be configured to optimize the maintenance tasks to achieve different goals or objectives. That is, the optimizer 740 may prioritize the components (and their associated maintenance tasks) differently based on the desired goal or objective. For example, the optimizer 740 may generate a list of maintenance tasks that minimize the lost revenue incurred by delaying the maintenance for a turbine, minimize the lost revenue incurred while the maintenance is being done, minimize the lost production of one or more turbines, minimize the risk of failure of critical components, maximize the utilization of value chain, and the like. Based on the desired objective and the NPVs, the optimizer 740 prioritizes the components—i.e., determines which component should be maintained first—and outputs a maintenance schedule 745 that may indentify the date the one or more maintenance task are take place, the respective turbines, the component on which service is to be performed, and the NPV of performing the task. The embodiments disclosed herein may be used to schedule any type of maintenance task associated with a power plant such as replacing a component or part of a component, routine maintenance (e.g., changing fluids, adding lubrication, checking for cracks, checking a sensor's output, and the like), repairing a damaged component, and the like. Moreover, the maintenance schedule may specify a technician or a required skill that is needed for performing a particular maintenance task or designate which maintenance crew should perform which tasks. One of ordinary skill in the art will recognize the different instructions and information that may be output from the maintenance scheduler.

In one embodiment, the NPV calculation module 725 and the maintenance schedule optimizer 740 may be located in the maintenance scheduler 200. For example, the maintenance scheduler 200 may be implemented using software, hardware, or some combination of both. The NPV module 725 and the optimizer 740 may be separate modules or applications within the scheduler 200. In other embodiments, the NPV module 725 and optimizer 740 may be separate from the maintenance scheduler 200—e.g., executed on remote computing systems.

The maintenance scheduler 200 may be executed using a computing system that includes a processor and a memory and may be included within a single turbine or located at a central location—e.g., the scheduler 200 may be part of a supervisory control and data acquisition (SCADA) system. Alternatively, the maintenance scheduler 200 may be located on a remote computer system that is communicatively coupled to the wind farm, for example, via the SCADA system. In one embodiment, the wind farm may be associated with a plurality of maintenance schedulers 200 that are each responsible for generating maintenance task for the components in a single turbine. Alternatively, a single maintenance scheduler 200 may be tasked with scheduling maintenance tasks for a plurality of wind turbines—e.g., all of the turbines in the farm or subset of the turbines in the farm.

Although the previous embodiments discussed integrating the different factors received by the maintenance scheduler into a NPV, this disclosure is not limited to such. For example, the factors may be used to generate any type of revenue indicator associated with the cost of performing maintenance on the turbine components. The revenue indicator may be the cost (or benefit) of performing the scheduled maintenance, the cost of waiting until the component fails, the cost of replacing the component versus repairing it, and the like.

Moreover, the previous embodiments described various techniques for scheduling maintenance tasks in a wind power plant—e.g., a wind farm. However, the same techniques may used (or modified) with other types of power plants as well. For example, a coal plant may have a plurality of generators that run off the same steam source. Maintenance on the generators may be scheduled based on identifying the NPV of the generators as described above. In one embodiment, the factors used in calculating the NPV may be modified if they do not apply; for example, because the power production of a generator in a coal plant may be steady, the NPV may not be generated using a predicted power production of the generators. Thus, one of ordinary skill in the art will recognize how the techniques above may be modified to apply to different types of power plants.

In the previous discussion, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### CONCLUSION

Determining when to perform preventative maintenance is an important consideration for maximizing the revenue of a wind turbine. For example, performing preventative maintenance may be cheaper than replacing turbine components when they fail. Nonetheless, a maintenance scheduler may consider multiple factors in deciding when to perform preventive maintenance actions. These factors may include the probability of failure, the energy-price, wind power production, resource constraints, and the like. Specifically, the maintenance scheduler may predict the future values of these factors which are then integrated into a NPV for each of the components. Based on the respective NPVs, the maintenance scheduler may determine which maintenance actions to perform and in what order.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A method of scheduling maintenance tasks in a power plant, comprising:
generating, based on a plurality of inputs, respective net present values associated with performing maintenance on two components in the power plant, wherein at least one of the plurality of inputs is a value that predicts at least one of: a future performance of the two components and a future price of electrical power;
determining a priority between the two components based on at least in part the respective net present values; and
generating, based on the determined priority, a maintenance schedule for performing a preventative maintenance task on at least one of the two components.

2. The method of claim 1, wherein at least two of the plurality of inputs predict a future performance of the two components by providing respective failure probabilities associated with the two components, the failure probabilities representing the likelihood the two components will fail during a predefined time period.

3. The method of claim 2, wherein the respective failure probabilities are based on a risk model and a risk curve generated by evaluating the historical data associated with components in the power plant similar to the two components.

4. The method of claim 1, wherein one of the plurality of inputs is a predicted energy price representing the expected price of electrical power on a utility grid coupled to the power plant.

5. The method of claim 1, wherein one of the plurality of inputs is a predicted power production of respective power generators associated with the two components.

6. The method of claim 1, wherein one of the plurality of inputs is at least one of: cost associated with labor, availability of spare parts to perform the maintenance task, and cost of spare parts.

7. The method of claim 1, wherein generating respective net present values comprises generating respective net present value curves for the two components, the net present value curves provide a plurality of predicted net present values for a range of future dates.

8. The method of claim 1, wherein determining the priority between the components comprises determining the maintenance schedule that maximizes the revenue of performing the maintenance task.

9. The method of claim 1, wherein the plurality of inputs are used to generate the respective net present values by comparing the total cost of performing the preventative maintenance task to performing a maintenance task in response to the two components failing.

10. The method of claim 1, wherein the power plant is a wind farm comprising a plurality of wind turbines, wherein first one of the two components is located in a first one of the plurality of wind turbines and a second one of the two components is located in a second one of the plurality of wind turbines.

11. A system, comprising:
a computer processor; and
a memory containing a program that, when executed on the computer processor, performs an operation for scheduling maintenance tasks in a power plant, comprising:
generating, based on a plurality of inputs, respective net present values associated with performing maintenance on two components in the power plant, wherein at least one of the plurality of inputs is a value that predicts at least one of: a future performance of the two components and a future price of electrical power;
determining a priority between the two components based on at least in part the respective net present values; and
generating, based on the determined priority, a maintenance schedule for performing a preventative maintenance task on at least one of the two components.

12. The system of claim 11, wherein at least two of the plurality of inputs predict a future performance of the two components by providing respective failure probabilities associated with the two components, the failure probabilities representing the likelihood the two components will fail during a predefined time period.

13. The system of claim 11, wherein one of the plurality of inputs is a predicted energy price representing the expected price of electrical power on a utility grid coupled to the power plant.

14. The system of claim 11, wherein one of the plurality of inputs is a predicted power production of respective power generators associated with the two components.

15. The system of claim 11, wherein the plurality of inputs are used to generate the respective net present values by comparing the total cost of performing the preventative maintenance task to performing a maintenance task in response to the two components failing.

16. A computer program product for scheduling maintenance tasks in a power plant, the computer program product comprising:
a computer-readable storage medium having computer-readable program code embodied therewith, the computer-readable program code comprising computer-readable program code configured to:
generate, based on a plurality of inputs, respective net present values associated with performing maintenance on two components in the power plant, wherein at least one of the plurality of inputs is a value that predicts at least one of: a future performance of the two components and a future price of electrical power;
determine a priority between the two components based on at least in part the respective net present values; and
generate, based on the determined priority, a maintenance schedule for performing a preventative maintenance task on at least one of the two components.

17. The computer program product of claim 16, wherein at least two of the plurality of inputs predict a future performance of the two components by providing respective failure probabilities associated with the two components, the failure probabilities representing the likelihood the two components will fail during a predefined time period.

18. The computer program product of claim 16, wherein one of the plurality of inputs is a predicted energy price representing the expected price of electrical power on a utility grid coupled to the power plant.

19. The computer program product of claim 16, wherein one of the plurality of inputs is a predicted power production of respective power generators associated with the two components.

20. The computer program product of claim 16, wherein the plurality of inputs are used to generate the respective net present values by comparing the total cost of performing the preventative maintenance task to performing a maintenance task in response to the two components failing.

21. A method of scheduling maintenance tasks in a wind power plant, comprising:
receiving a probability of failure associated with a component in a wind turbine in the wind power plant;
receiving a predicted energy price representing an expected price of electrical power on a utility grid coupled to the wind power plant;
receiving a predicted wind power production of the wind turbine representing an expected amount of power that will be produced by the wind turbine;
generating, based on the probability of failure, predicted energy price and predicted wind power production, a revenue indicator associated with performing maintenance on the component; and
generating, based on the revenue indicator, a maintenance schedule for performing a preventative maintenance task on the component.
